(19) United States
(12) Patent Application Publication
(10) Pub. No.: US 2005/0097172 A1
(43) Pub. Date: May 5, 2005

(54) Open letter electronic influencing intercommunication system

(76) Inventor: August L. Stemmer, Novato, CA (US)

Correspondence Address: August L. Stemmer, 1280 Lynwood Dr., Novato, CA, 94947, US

(21) Appl. No.: 10/679,277

(22) Filed: Oct. 7, 2003

(51) Int. Cl. G06F 15/16

(52) U.S. Cl. 709/206

(57) ABSTRACT

The Open Letter Electronic Influencing Intercommunication System, invention known commonly as Open-Letters, through its newly developed interactive computer method over the Internet is here described. It uniquely combines the ability to rapidly collect and compile data over the Internet in order to bring the results of its assimilation and analysis together more rapidly through the use of an electronic computer system to influence another individual more effectively, capably and economically through its action—together with the use of a previously know process, such as in the instant case is commonly known as an Open Letter to the Editor of a newspaper. The inventor makes three claims for his method.

The nature of my invention consists of the use of a software program, in part written in the HTML programming language. It can be called up on the users browser thru the use of a URL—referencing the name in the form: http://www.Open-Letters.com. Once this program has entered the user's computer, by way of his or her browser, it immediately gives the user access to the internet so that he or she can publish letters or other material without his or her having to make their own Web publishing arrangements because the Open-Letters system can both store the material and does the publication over the internet through the use of its computer server or servers.

Up to this point the method of the system process would be no different than any of the other computer systems used for the enlightenment and or entertainment of the public over the internet, however the Open-Letters publishing system then takes this, here-to-fore well known, process one step further in order to enhance the effectiveness and capability of achieving influential communication through the use of what now commonly is termed interactive computing. Its novelty lies in the fact that, although open letters have been published in newspapers and the like in the past, often in Letters to the Editor, this concept of using a central area of communication for a vast number of people rather than the fragmentation of separate publications, has not been used as a central clearing mechanism for achieving a specific action through the vastly larger medium of internet communication—thereby reaching many more individuals who can be persuaded by the content of the communication from the party of the first part to the party of the second part, thus having a greater influence in order to achieve a desired response from the party of the second part. An example of the mechanism of action is as follows:

Through the use of otherwise well known interactive programming techniques the user is able to search the data base and or the internet at-large to find various selective meaningful data which can be used to take part in the process that he or she wishes to use in order to influence another individual or entity which is to be ‘effected’ in a business nature or any other manner. Having arrived at his or her desired information through computer selection, or in any other manner, the user activates his or her wishes in the system—often after detailed research within the system and or through the Internet. The system then itself in turn, through its unique use of well known interactive programming techniques and or conventional methods of communication such as email or regular mail, makes the individual or entity who is to be influenced aware that the user, through the use of this ever increasing method of providing general knowledge and exposure to the public—because of the meaning of the open letters concept being already generally know to the public, will expect the response that he or she seeks or else the entity to be effected will risk suffering the moral if not monetary disapproval of the public at large as a result of the broad internet publication—if the desired response is not obtained. Thus if the desired response, from the party of the second part to the request of the party of the first part, is not immediately forthcoming then the request of the party of the first part having actually now been published over the internet will remain active for a specific period of time with hopes that either the party of the second part will respond with an explanation as to why or else run the risk that a greater number of internet receivers will react sympathetically to the content of the request thus expressing moral indignation or actual boycott of an item of commerce.

A simplified instance of this mechanism of action would be that the user has had some difficulty with an employee of a large corporation and after researching the system's data to arrive at the necessary email address of the corporation—which he wishes to effect, and perhaps also after recognizing other similar problems that may or may not have been previously stored in the system and which have already effected other users, he makes the corporation aware of the information and data that he might otherwise not have had readily at hand and then fashions an initial primary communication, or a secondary communication if contact had already been made to the corporation, using the Open-Letters system and requests that certain action be remedially taken by the corporation.
In this correspondence, under the name of the system, it is clarified that if the requested action is not taken the system will make the entire file available to the public over the Internet as well as through conventional means. Likewise the effected corporation (the party of the second part) is automatically given the right, by the system, to publish at the same level of importance and edifiction its reply to the user (party of the first part) before there is any general publication of transmittals—in order to avoid showing favoritism by the system.

Both user (party of the first part) and effected individual (party of the second part) can be charged a fee for the use of the method in the form of a service fee, but the system's method does not depend upon the incorporation of a charge as its main component—rather it depends upon the power of the Internet, coupled with the systems ability to achieve unanimity, to motivate an action which can often depend upon the combined moral pressure of a multitude.

1. As the inventor of this computer process and method I make the following claims:
1. To the uniqueness and novelty of this system to accomplish more effectively and capably and economically what here-to-fore has been accomplished through the printed word in newspapers and the like—faster and easier through the speed of computing and across the Internet.
2. To the uniqueness and novelty of this system to accomplish more effectively and capably and economically what here-to-fore has been accomplished through the printed word in newspapers and the like—a better result through the wider dissemination of the user's communication by using the Internet to achieve a greater moral and economic importance.
3. To the uniqueness and novelty of this system to accomplish more effectively and capably and economically what here-to-fore has been accomplished through the printed word in newspapers and the like—more influentially through the users easier ability to search a large data base used by such search engines as Google and Yahoo, thereby being able to immediately apply the gleaned information to his or her personal use, through certain previously known communication processes, to a larger potential audience usually when the desired response sought by the user is not forthcoming.
